(19) United States
(12) Patent Application Publication
(10) Pub. No.: US 2024/0019951 A1
(43) Pub. Date: Jan. 18, 2024

(54) DISPLAY PANEL AND ELECTRONIC DEVICE

(71) Applicants: Wuhan China Star Optoelectronics Technology Co., Ltd., Wuhan, Hubei (CN); Wuhan China Star Optoelectronics Semiconductor Display Technology Co., Ltd., Wuhan, Hubei (CN)

(72) Inventors: Weiwei YANG, Wuhan (CN); Guochao WANG, Wuhan (CN)

(21) Appl. No.: 17/608,145

(22) PCT Filed: Jul. 20, 2021
(86) PCT No.: PCT/CN2021/107300

§ 371 Date: Nov. 1, 2021

(30) Foreign Application Priority Data
Jun. 25, 2021 (CN) 202110708688.9

(51) Int. Cl. G06F 3/041

(52) U.S. Cl. CPC G06F 3/0412; G06F 3/04164; G06F 2203/04102; G06F 2203/04103

(57) ABSTRACT

A display panel and an electronic device are provided. The display panel includes a display touch zone and a side frame zone. The side frame zone includes a bending zone and a bonding zone. The display panel specifically includes a driving circuit layer, a light emission function layer, and a touch control function layer. The driving circuit is electrically connected, by means of the first conduction layer, to bonding terminals located in the bonding zone. The touch control circuit is extended, by means of the second conduction layer, across the bending zone and is then connected, by means of the first conduction layer to the bonding terminals of the bonding zone. The display panel of the application has a side frame of which a width is made smaller.

### FIELD OF INVENTION

The present invention relates to display technologies, and more particularly, to a display panel and an electronic device.

### BACKGROUND OF INVENTION

An organic light emitting display (OLED) panel has various advantages, including self-luminescence, low driving voltage, high luminescence efficiency, short response time, high definition and contrast, virtually 180° view angle, and wide range of operation temperature, and has been widely used in smart phones, tablet computers, and full-color televisions.

A conventional OLED display panel includes a touch control circuit that is directly deposited on an encapsulation layer of the display panel as a substitute for an externally mounted touch screen, in order to save cost. An conventional self-capacitance touch display panel generally includes various sensors, such as an image sensor, a fingerprint sensor, and a pressure sensor, integrated thereon. The sensors include a relatively large number of signal transmission lines. In order to better arrange these signal transmission lines, as shown in FIGS. 1 and 2, it is common to make line-switching of touch control circuit wirings from an upper side of a screen lower frame bending zone to a driving circuit wiring layer of the display panel. Due to the line-switching structure, the width of the lower frame of the display panel cannot be further reduced, making it not better satisfy the needs of a user for seeking for an extremely narrow frame for a display panel.

### SUMMARY OF INVENTION

Embodiments of the application provide a display panel and an electronic device, which help resolve the technical issue that the frame width of a known display panel cannot be further reduced.

To resolve the above issue, the application provides a technical solution as follows:

An embodiment of the application provides a display panel, comprising a display touch zone and a side frame zone, the side frame zone comprising a bending zone and a bonding zone, the display panel comprising:
a driving circuit layer, which is formed with a driving circuit;
a light emission function layer;
a touch control function layer, which is formed with a touch control circuit;
wherein in the side frame zone, the display panel comprises a first conduction layer and a second conduction layer, the driving circuit being electrically connected, by means of the first conduction layer, to bonding terminals located in the bonding zone, the touch control circuit being extended, by means of the second conduction layer, across the bending zone to connect, by means of the first conduction layer, to the bonding terminals located in the bonding zone.

In the display panel of the application, in the bending zone, the first conduction layer is located on one side of the second conduction layer that is subject to bending and the first conduction layer is arranged as a constant voltage signal circuit.

In the display panel of the application, the second conduction layer comprises a touch-control-circuit connection section and a bonding-terminal connection section, the touch-control-circuit connection section has an end electrically connected to the touch control circuit and an opposite end connected, in the bending zone, to an end of the bonding-terminal connection section, an opposite end of the bonding-terminal connection section is connected to the bonding terminals.

In the display panel of the application, the bonding-terminal connection section and the touch-control-circuit connection section are connected such that wirings of the bonding-terminal connection section and wirings of the touch-control-circuit connection section are connected to form an included angle ranging from 30° to 150°.

In the display panel of the application, the bonding terminals comprise drive bonding terminals and touch-control bonding terminals, the touch-control bonding terminals are located on two side portions of the bonding zone, the drive bonding terminals are located on a middle portion of the bonding zone, the first conduction layer is electrically connected to the drive bonding terminals, the second conduction layer is electrically connected to the touch-control bonding terminals.

In the display panel of the application, the second conduction layer and the touch-control bonding terminals are connected such that wirings of the second conduction layer are connected to the touch-control bonding terminals to form an included angle ranging from 90° to 170°.

In the display panel of the application, the first conduction layer is located in a middle area of the second conduction layer, and at least a portion of the second conduction layer overlaps the first conduction layer.

In the display panel of the application, the second conduction layer comprises multiple touch wirings, and each of the touch wirings comprises multiple curving portions and multiple linear portions, the curving portions and the linear portions are alternately arranged in intervals with each other.

In the display panel of the application, the curving portions comprise first curving portions and second curving portions, the first curving portions having a curving direction that is opposite to a curving direction of the second curving portions; and each of the linear portions has an end connected to the first curving portions and an opposite end connected to the second curving portions.

An embodiment of the application also provides an electronic device, which comprises a display panel, a drive chip, and a touch control chip, the display panel comprising a display touch zone and a side frame zone, the side frame zone comprising a bending zone and a bonding zone, the display panel comprising:
a driving circuit layer, which is formed with a driving circuit;
a light emission function layer;
a touch control function layer, which is formed with a touch control circuit;
wherein in the side frame zone, the display panel comprises a first conduction layer and a second conduction layer, the driving circuit being electrically connected, by means of the first conduction layer, to bonding terminals located in the bonding zone, the touch control circuit being extended, by means of the second conduction layer, across the bending zone to connect, by means of the first conduction layer, to the bonding terminals located in the bonding zone.

In the electronic device of the application, in the bending zone, the first conduction layer is located on one side of the second conduction layer that is subject to bending and the first conduction layer is arranged as a constant voltage signal circuit.

In the electronic device of the application, the second conduction layer comprises a touch-control-circuit connection section and a bonding-terminal connection section, the touch-control-circuit connection section has an end electrically connected to the touch control circuit and an opposite end connected, in the bending zone, to an end of the bonding-terminal connection section, an opposite end of the bonding-terminal connection section is connected to the bonding terminals.

In the electronic device of the application, the bonding-terminal connection section and the touch-control-circuit connection section are connected such that wirings of the bonding-terminal connection section and wirings of the touch-control-circuit connection section are connected to form an included angle ranging from 30° to 150°.

In the electronic device of the application, the bonding terminals comprise drive bonding terminals and touch-control bonding terminals, the touch-control bonding terminals are located on two side portions of the bonding zone, the drive bonding terminals are located on a middle portion of the bonding zone, the first conduction layer is electrically connected to the drive bonding terminals, the second conduction layer is electrically connected to the touch-control bonding terminals.

In the electronic device of the application, the second conduction layer and the touch-control bonding terminals are connected such that wirings of the second conduction layer are connected to the touch-control bonding terminals to form an included angle ranging from 90° to 170°.

In the electronic device of the application, the first conduction layer is located in a middle area of the second conduction layer, and at least a portion of the second conduction layer overlaps the first conduction layer.

In the electronic device of the application, the second conduction layer comprises multiple touch wirings, and each of the touch wirings comprises multiple curving portions and multiple linear portions, the curving portions and the linear portions are alternately arranged in intervals with each other.

In the electronic device of the application, the curving portions comprise first curving portions and second curving portions, the first curving portions have a curving direction that is opposite to a curving direction of the second curving portions; and each of the linear portions has an end connected to the first curving portions and an opposite end connected to the second curving portions.

The beneficial effect of the present disclosure is that the application provides, in embodiments thereof, a display panel and an electronic device. The display panel comprises a display touch zone and a side frame zone. The side frame zone comprises a bending zone and a bonding zone. The display panel comprises: a driving circuit layer that is formed with a driving circuit, a light emission function layer, and a touch control function layer that is formed with a touch control circuit. In the side frame zone, the display panel comprises a first conduction layer and a second conduction layer. The driving circuit is electrically connected, by means of the first conduction layer, to the bonding terminals located in the bonding zone. The touch control circuit is extended, by means of the second conduction layer, across the bending zone and is then connected, by means of the first conduction layer, to the bonding terminals located in the bonding zone. In the embodiments of the application, the driving circuit is electrically connected, by means of the first conduction layer, to the bonding terminals located in the bonding zone, and the touch control circuit is extended, by means of the second conduction layer, across the bending zone and is then connected, by means of the first conduction layer, to the bonding terminals located in the bonding zone. In this way, there is no need for line-switching of the touch control circuit to the driving circuit layer, and a distance necessary for line-switching of the second conduction layer in the bending zone toward the first conduction layer can be saved, so that the bending zone of the display panel can be made closer to the display touch zone, and after bending of the side frame zone, a spacing distance between an edge of the display touch zone and the side frame zone is lessened, achieving an effect of further narrowing the side frame of the display panel, thereby resolving the technical issue that the frame width of a known display panel cannot be further reduced.

### DESCRIPTION OF DRAWINGS

To describe more clearly the technical solutions of the embodiments or the prior art, the following provides a brief description for the drawings that are necessary for illustrating the embodiments or the prior art. Obviously, the drawings as described below illustrate only some embodiments of the application, and for those having ordinary skill in the field, other drawings may be contemplated according to the attached drawings without making creative endeavor.

FIG. 1 is a schematic view showing a structure of a lower frame of a prior art display panel.

FIG. 2 is a cross-sectional view taken in direction A-A of FIG. 1.

FIG. 3 is a cross-sectional view taken in direction B-B of FIG. 1.

FIG. 4 is a schematic view showing a structure of a lower frame of a display panel according to an embodiment of the application.

FIG. 5 is a cross-sectional view taken in direction A′-A′ of FIG. 4.

FIG. 6 is a cross-sectional view taken in direction B′-B′ of FIG. 4.

FIG. 7 is a schematic view showing a structure of touch control wirings on a second conduction layer according to an embodiment of the application.

### DETAILED DESCRIPTION OF PREFERRED EMBODIMENTS

The following description of each embodiment makes reference to the attached drawings to provide an example illustration of specific embodiments in which the application may be implemented. Direction related terms as used in the application, such as “up”, “down”, “front”, “rear”, “left”, “right”, “inside”, “outside”, and “lateral side”, indicate directions by referring to the attached drawings. Thus, the use of the direction related terms is for illustration and understanding of the application and is not intended to limit the application. In the drawings, elements having similar structures are designated with the same reference numerals.

Embodiments of the application provide a display panel and an electronic device, which overcome the technical issue that a frame width of an existing display panel cannot be further reduced.

The display panel according to an embodiment of the application includes a display touch zone and a side frame zone. The side frame zone includes a bending zone and a bonding zone. The display panel includes a driving circuit layer, a light emission function layer, and a touch control function layer. The driving circuit layer is formed with a driving circuit. The touch control function layer is formed with a touch control circuit. In the side frame zone, the display panel includes a first conduction layer and a second conduction layer. The driving circuit is electrically connected, by means of the first conduction layer, to bonding terminals located in the bonding zone. The touch control circuit is extended, by means of the second conduction layer, across the bending zone and is then connected, by means of the first conduction layer, to the bonding terminals located in the bonding zone.

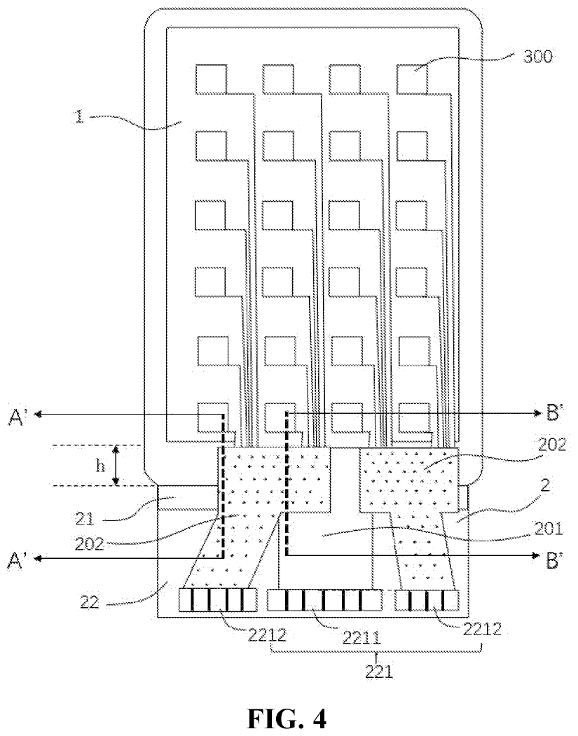

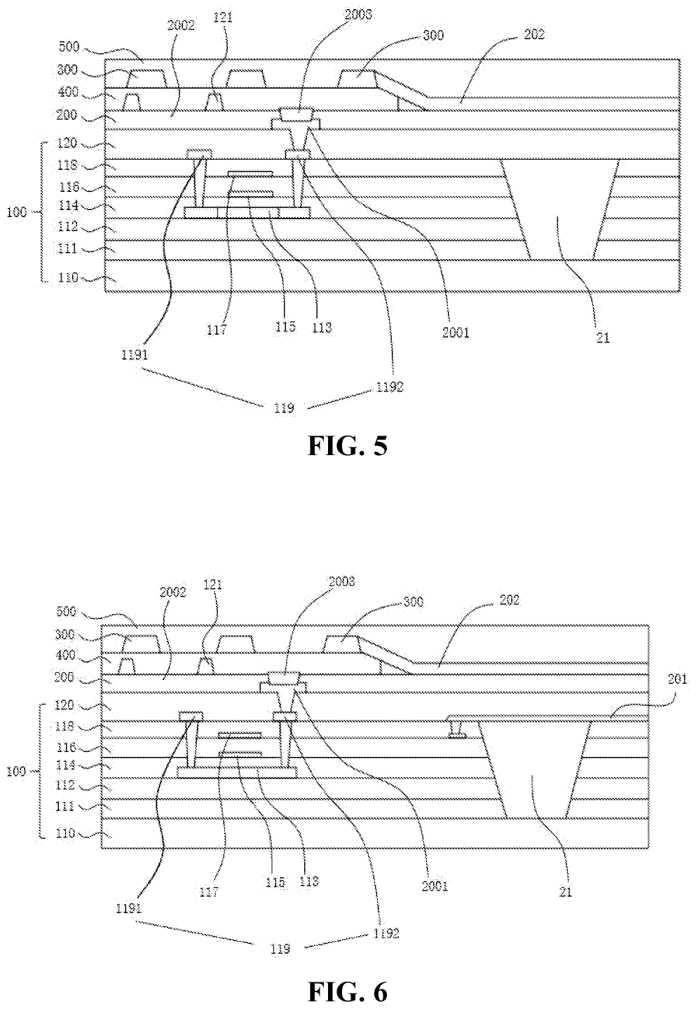

As shown in FIGS. 4-6, FIG. 4 is a schematic view showing a structure of a lower frame of a display panel according to an embodiment of the application; FIG. 5 is a cross-sectional view taken in direction A′-A′ of FIG. 4; and FIG. 6 is a cross-sectional view taken in direction B′-B′ of FIG. 4. The display panel comprises a display touch zone 1 and a side frame zone 2. The side frame zone 2 comprises a bending zone 21 and a bonding zone 22. The display panel specifically comprises a driving circuit layer 100, a light emission function layer 200, and a touch control function layer 300. The driving circuit layer 100 is formed with a driving circuit; the touch control function layer 300 is formed with a touch control circuit. In the side frame zone 2, the display panel comprises a first conduction layer 201 and a second conduction layer 202. The driving circuit is electrically connected, by means of the first conduction layer 201, to bonding terminals 221 located in the bonding zone 22, and the touch control circuit is extended, by means of the second conduction layer 202, across the bending zone 21 to be then connected, by means of the first conduction layer 201, to the bonding terminals 221 located in the bonding zone 22.

Based on the laying direction of FIG. 4, in an embodiment of the application, the side frame zone 2 is located below the display touch zone 1. Based on the direction of FIGS. 5 and 6, to assemble the display panel to an electronic device (such as a mobile phone and a tablet computer), the side frame zone 2 is bent downward along the bending zone 21, such that a lower frame width h of the display panel as exhibited in the electronic device is a spacing distance between an upper end of the bending zone 21 and a lower end of the display touch zone 1.

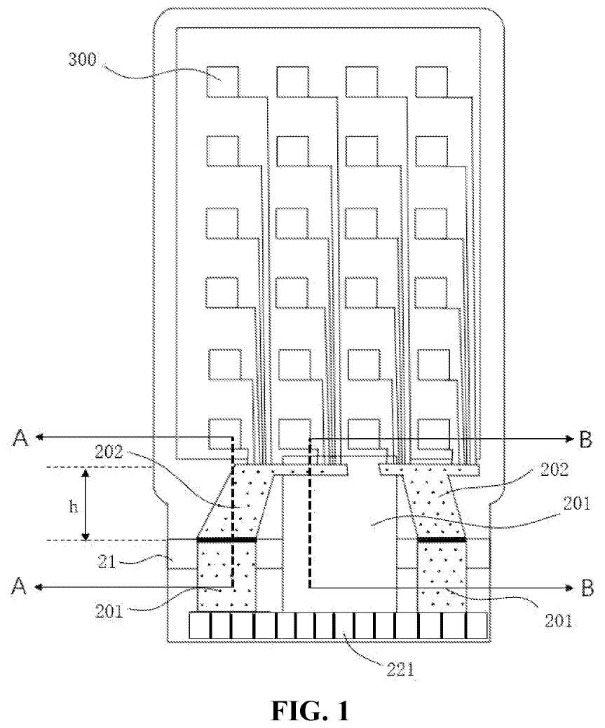

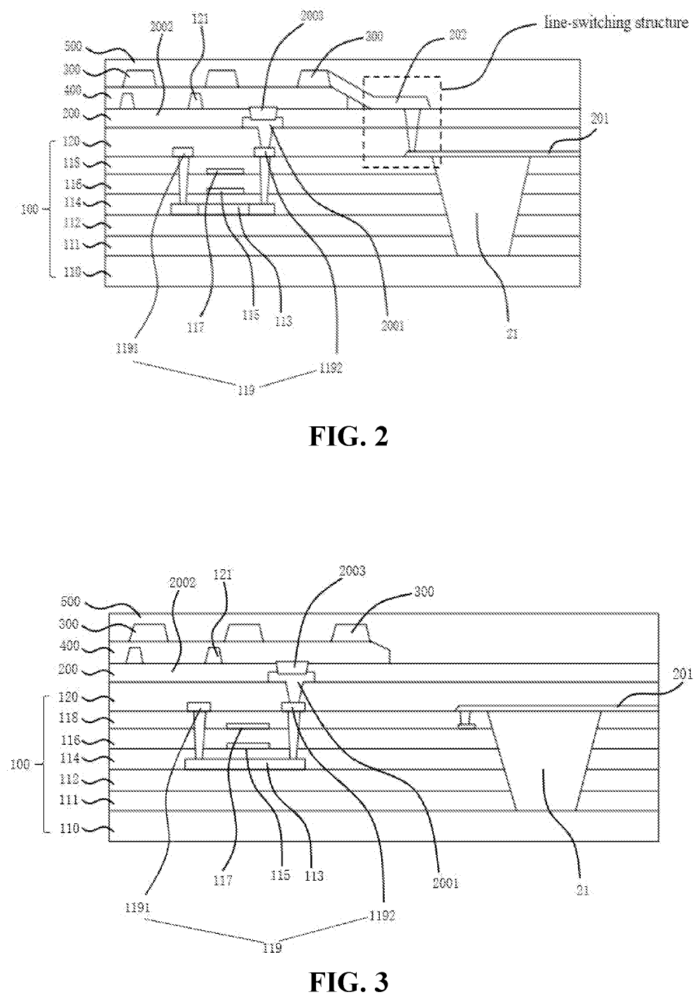

As shown in FIGS. 1-3, FIG. 1 is a schematic view showing a structure of a lower frame of a prior art display panel; FIG. 2 is a cross-sectional view taken in direction A-A of FIG. 1; and FIG. 3 is a cross-sectional view taken in direction B-B of FIG. 1. In the prior art, it is common to implement line-switching from a second conduction layer 202 above a bending zone 21 toward a first conduction layer 201, and due to the line-switching structure, a width h of the lower frame, after bending of the display panel, cannot be further reduced.

In an embodiment of the application, the driving circuit is electrically connected, by means of the first conduction layer 201, to the bonding terminals 221 located in the bonding zone 22, and the touch control circuit is extended, by means of the second conduction layer 202, across the bending zone 21 to connected by the first conduction layer 201 to the bonding terminals 221 of the bonding zone 22. In this way, there is no need for line-switching of the touch control circuit to the driving circuit layer, and a distance necessary for line-switching of the second conduction layer 202 in the bending zone 21 toward the first conduction layer 201 can be saved, so that the bending zone 21 of the display panel can be made closer to the display touch zone 1, and after bending of the side frame zone 2, a spacing distance between an edge of the display touch zone 1 and the side frame zone 2 is lessened, achieving an effect of further narrowing the side frame of the display panel.

In the bending zone 21, the first conduction layer 201 is located at one side of the second conduction layer 202 that is subject to bending, and the first conduction layer 201 is arranged as a constant voltage signal circuit. This ensures the touch control signal of the touch control circuit and a driving signal of the driving circuit can be stably transmitted.

The second conduction layer 202 comprises a touch-control-circuit connection section and a bonding-terminal connection section. The touch-control-circuit connection section has one end electrically connected to the touch control circuit and an opposite end connected, in the bending zone 21, to an end of the bonding-terminal connection section. An opposite end of the bonding-terminal connection section is connected to the bonding terminals. In this way, when the display panel is bent, the second conduction layer 202 undergoes bending along the connection between the touch-control-circuit connection section and the bonding-terminal connection section in the bending zone 21 to help enhance an effect of bending of the bending zone 21.

The bonding-terminal connection section and the touch-control-circuit connection section are connected such that wirings of the bonding-terminal connection section and wirings of the touch-control-circuit connection section are connected to form an included angle in a range of 30° to 150°. Such an arrangement of angle allows the wirings are still well connected after the second conduction layer 202 is bent.

The bonding terminals 221 comprise drive bonding terminals 2211 and touch-control bonding terminals 2212. The touch-control bonding terminals 2212 are arranged on two side portions of the bonding zone 22, while the drive bonding terminals 2211 are located in a middle portion of the bonding zone 22. The first conduction layer 201 is electrically connected to the drive bonding terminals 2212, and the second conduction layer 202 is electrically connected to the touch-control bonding terminals 2212. In this way, when the side frame zone 2 is bent, the first conduction layer 201 and the second conduction layer 202 can be easy to bend and do not interfere with each other.

The second conduction layer 202 is connected to the touch-control bonding terminals such that an edge of the second conduction layer 202 forms an included angle with respect to the touch-control bonding terminals in a range of 90° to 170°. Such an arrangement of angle allows the second conduction layer 202 to form good connection with the bonding terminals during bending.

The first conduction layer 201 is located in a middle area of the second conduction layer 202, and at least a portion of the second conduction layer 202 overlaps the first conduction layer 201. In this way, the first conduction layer 201 and the second conduction layer 202 can be easy to bend during bending and do not interfere with each other.

The driving circuit layer 100 comprises a flexible substrate 110, and a barrier layer 111, a buffer layer 112, an active layer 113, a first gate insulation layer 114, a first gate electrode 115, a second gate insulation layer 116, a second gate electrode 117, a dielectric layer 118, source-drain electrodes 119, and a planarization layer 120 that are sequentially arranged on the flexible substrate 110 in a light exiting direction. In the arrangement, the first gate electrode 115 is located on the first gate insulation layer 114; the second gate insulation layer 116 has a portion overlapping the first gate electrode 115 and another portion overlapping the first gate insulation layer 114. The second gate electrode 117 is located on the second gate insulation layer 116. The dielectric layer 118 has a portion overlapping the second gate electrode 117 and another portion overlapping the second gate insulation layer 116.

The barrier layer 111 is located on the flexible substrate 110. The buffer layer 112 is located on the barrier layer 111. The active layer 113 is located on the buffer layer 112. The first gate insulation layer 114 is located on the active layer 113. The first gate electrode 115 is located on the first gate insulation layer 114. The second gate insulation layer 116 is located on the first gate insulation layer 114 and covers the first gate electrode 115. The second gate electrode 117 is located on the second gate insulation layer 116. The dielectric layer 118 is located on the second gate insulation layer 116 and covers the second gate electrode 117. The source-drain electrodes 119 are located on the dielectric layer 118. The planarization layer 120 is located on the dielectric layer 118 and covers the source-drain electrodes 119.

The source-drain electrodes 119 comprise a source electrode 1191 and a drain electrode 1192. The source electrode 1191 and the drain electrode 1192 are located on the planarization layer 120 and are both connected by means of a semiconductor component to the active layer.

The dielectric layer 118, the second gate insulation layer 116, and the first gate insulation layer 114 are each formed with through holes. The active layer 113 is provided with a source connection zone and a drain connection zone. The semiconductor components extend through the through holes, and the source electrode 1191 is connected by the semiconductor component to the source connection zone of the active layer 113, and the drain electrode 1192 is connected by the semiconductor component to the drain connection zone of the active layer 113. The source connection zone and the drain connection zone comprise conductorized metal oxide semiconductor material.

An orthographic projection of the barrier layer 111 cast on the flexible substrate 110 covers an orthographic projection of the active layer 113 cast on the flexible substrate 110, so that the barrier layer 111 completely covers the active layer 113, preventing the active layer 113 from irradiation by light and avoiding negative shifting of a threshold voltage of the thin film transistor.

In an embodiment of the application, in the side frame zone 2, the first conduction layer 201 is located on the dielectric layer and is covered by the planarization layer. In this way, the dielectric layer and the planarization layer provide an effect protection to the first conduction layer 201.

In an embodiment of the application, in the display touch zone 1, the light emission structure layer 200 comprises an anode layer 2001, and a pixel definition layer 2002, a light emission layer (OLED) 2003, and a cathode layer that are sequentially disposed on the anode layer 2001 in the light exiting direction.

The anode layer 2001 is located on the planarization layer 120. The pixel definition layer 2002 is located on the anode layer 2001. The light emission layer 2003 is located on the pixel definition layer 2002. The cathode layer is located on the light emission layer 2003. The pixel definition layer 2002 is arranged in a separated manner to form a pixel aperture. A portion of the light emission layer 2003 that corresponds to the pixel aperture is laid flat on the anode layer 2001. A portion of the cathode layer that corresponds to the pixel aperture is laid flat on the light emission layer 2003. The anode layer 2001 is set in electrical contact engagement with the drain electrode 1192 of the thin-film transistor layer by means of an anode via. The source electrode 1191 is connected to a positive electrode of an external power source. The cathode layer is electrically connected, by means of a power wiring layer, to a negative electrode of the external power source. When the anode layer 2001 and the cathode layer are provided therebetween with a direct-current (DC) voltage of 2V to 10V, the anode layer 2001 generates holes, and the cathode layer generates electrons. When coming across each other in the light emission layer 2003, the electrons and the holes, which respectively carry negative and positive charges, attract each other to excite an organic light emission material contained in the light emission layer 2003 to realize normal operation of the display panel. By controlling the level of the voltage applied between the anode layer 2001 and the cathode layer, the luminous brightness of the light emission layer 2003 can be adjusted, and the greater the voltage is, the higher the brightness will be, otherwise the brightness goes down. Based on different formulas, three primary colors of red, green, and blue (R, G, B) can be generated to form elementary colors.

In the side frame zone 2, the light emission function layer comprises the pixel definition layer, and the second conduction layer 202 is located on the pixel definition layer. The pixel definition layer provides an excellent support to the second conduction layer 202.

In an embodiment of the application, the display panel further comprises a support layer 121, an encapsulation layer 400, and a touch insulation layer 500. The encapsulation layer 400 is set on and covers the pixel definition layer 2002 and the light emission layer 2003. The touch insulation layer 500 is set on and covers the touch control function layer 300. The support layer 121 is arranged between the encapsulation layer 400 and the light emission layer 2003 to provide support to the encapsulation layer 400, the touch control function layer 300, the touch insulation layer 500 that is located on the encapsulation layer 400.

In an embodiment of the application, the touch insulation layer 500 is specifically an organic insulation layer. In the display touch zone 1, the organic insulation layer 500 is set on and covers the touch control function layer 300; and in the side frame zone 2, the organic insulation layer 500 is set on and covers the pixel definition layer 2002. The organic insulation layer 500 provides insulating protection to the touch control function layer 300 to prevent the touch control signal from being interfered with by other electrical signals to become failure of touch control.

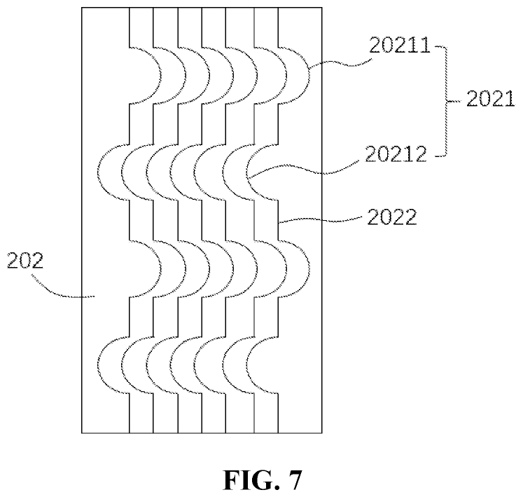

In an embodiment of the application, as shown in FIG. 7, which is a schematic view showing a structure of touch control wirings on the second conduction layer according to an embodiment of the application, the second conduction layer 202 comprises multiple touch wirings, and each of the touch wirings comprises multiple curving portions 2021 and multiple linear portions 2022. The curving portions 2021 and the linear portions 2022 are alternately arranged in intervals with each other.

This would improve the overall robustness of the touch wirings, so that when the second conduction layer 202 is being bent, the touch wirings does not readily break and would allow for enlargement of an angle of bending.

In an embodiment, the curving portions 2021 comprise first curving portions 20211 and second curving portions 20212. The first curving portions 20211 have a curving direction that is opposite to a curving direction of the second curving portions 20212. An end of each of the linear portions 2022 is connected to the first curving portions 20211, and an opposite end connected to the second curving portions 20212.

This would further enhance the overall robustness of the touch wirings, allowing the second conduction layer to be bent in an even larger angle, making the width h of the side frame zone even smaller after bending.

Based on the direction illustrated in FIG. 7, a length of the curving portions 2021 in a vertical direction is not less than a length of the linear portions 2022. This would further enhance the overall robustness of the touch wirings, allowing the angle of bending of the touch wirings to be further enlarged.

In an embodiment of the application, the manufacturing of the display panel employs an OLED vapor deposition process and a thin-film encapsulation process. In the manufacturing, the OLED vapor deposition process comprises the following steps:

Firstly, an indium tin oxide ITO (electrically conductive glass) substrate is subjected to pre-deposition treatment: the ITO substrate being sequentially subjected to brush washing with cleaning solution, ultrasonic cleaning with cleaning solution, and pure water ultrasonic cleaning that is repeated three times, and then subjected to drying and being placed in a vacuum sampler chamber that is evacuated to a vacuum level of 5.0E-0.4 Pa, rotational speed of a rotary tray being 5 r/min.

Next, the ITO substrate so pre-treated is placed in a vapor deposition chamber, and a vacuum level of the vapor deposition chamber is controlled to be 2.0E-5 Pa, and vapor deposition is implemented to laminate, in sequence, a hole injection layer, a hole transport layer, and an electron blocking layer on the ITO substrate, wherein the hole injection layer is formed, through vapor deposition, of a triphenylamine derivate heated to 235° C., at a rate of 0.97 Å/s-1.03 Å/s, and also tetrafluorobenzonitrile heated to 265° C., the two being doping at 3%. The hole transport layer is formed, through vapor deposition, of solely a triphenylamine derivate heated to 235° C., at a rate of 0.97 Å/s-1.03 Å/s. The electron blocking layer is formed, through vapor deposition, of solely a spiro fluorene derivate heated to 225° C., at a rate of 0.97 Å/s-1.03 Å/s.

Next, ternary vapor deposition is implemented by placing a platinum compound (light emission guest material) and DPQP (hole type host material) on a same rotary tray, placing a derivate of 2,4,6-triphenyl-1,3,5-triazine outside the rotary tray, sequentially heating the derivate of 2,4,6-triphenyl-1,3,5-triazine (heating temperature being 225° C., and vapor-deposition rate being 0.91 Å/s-0.97 Å/s) and the platinum compound (heating temperature being 255° C., and vapor-deposition rate being 0.11 Å/s-0.13 Å/s), such that when the vapor-deposition rate of the platinum compound become stable, DPQP is then heated to 225° C., and when the vapor-deposition rates of the platinum compound and DPQP reach 1.06 Å/s, the rotary tray is activated and the rotary tray is controlled to have a rotational speed of 10 r/min, and then a baffle is then opened and the vapor deposition is continued to obtain the light emission layer.

Finally, vapor deposition is implemented to laminate, in sequence, an electron transport layer, an electron injection layer, and a cathode on the light emission layer, wherein the electron transport layer is formed, through vapor deposition, of 8-quinolinolato lithium (LiQ) and an anthracene derivate heated to 285° C., at a rate in a mixed manner. The electron injection layer is formed, through vapor deposition, of solely metallic Yb heated to 1000° C., at a rate. The cathode is formed, through vapor deposition, solely of metallic Ag heated to 1200° C., at a rate of 0.97 Å/s-1.03 Å/s to eventually obtain an OLED device product.

An embodiment of the application also provides an electronic device, which comprises a display panel, a drive chip, and a touch control chip. The display panel comprises a display touch zone and a side frame zone. The side frame zone comprises a bending zone and a bonding zone. The display panel comprises:
a driving circuit layer, which is formed with a driving circuit;
a light emission function layer;
a touch control function layer, which is formed with a touch control circuit;
wherein in the side frame zone, the display panel comprises a first conduction layer and a second conduction layer, the driving circuit being electrically connected, by means of the first conduction layer, to bonding terminals located in the bonding zone, the touch control circuit being extended, by means of the second conduction layer, across the bending zone to connect, by means of the first conduction layer, to the bonding terminals located in the bonding zone.

In an embodiment, in the bending zone, the first conduction layer is located on one side of the second conduction layer that is subject to bending and the first conduction layer is arranged as a constant voltage signal circuit.

In an embodiment, the second conduction layer comprises a touch-control-circuit connection section and a bonding-terminal connection section, the touch-control-circuit connection section have an end electrically connected to the touch control circuit and an opposite end connected, in the bending zone, to an end of the bonding-terminal connection section, an opposite end of the bonding-terminal connection section is connected to the bonding terminals.

In an embodiment, the bonding-terminal connection section and the touch-control-circuit connection section are connected such that wirings of the bonding-terminal connection section and wirings of the touch-control-circuit connection section are connected to form an included angle ranging from 30° to 150°.

In an embodiment, the bonding terminals comprises drive bonding terminals and touch-control bonding terminals, the touch-control bonding terminals are located on two side portions of the bonding zone, the drive bonding terminals are located on a middle portion of the bonding zone, the first conduction layer is electrically connected to the drive bonding terminals, the second conduction layer is electrically connected to the touch-control bonding terminals.

In an embodiment, the second conduction layer and the touch-control bonding terminals are connected such that wirings of the second conduction layer are connected to the touch-control bonding terminals to form an included angle ranging from 90° to 170°.

In an embodiment, the first conduction layer is located in a middle area of the second conduction layer, and at least a portion of the second conduction layer overlaps the first conduction layer.

In an embodiment, the second conduction layer comprises multiple touch wirings, and each of the touch wirings comprises multiple curving portions and multiple linear portions, the curving portions and the linear portions are alternately arranged in intervals with each other.

In an embodiment, the curving portions comprises first curving portions and second curving portions, the first curving portions having a curving direction that is opposite to a curving direction of the second curving portions; and each of the linear portions has an end connected to the first curving portions and an opposite end connected to the second curving portions.

In an embodiment of the application, the drive bonding terminals are electrically connected to the drive chip, and the touch-control bonding terminals are electrically connected to the touch control chip. The drive chip controls, by means of the drive bonding terminals and the driving circuit, a displaying operation of the display touch zone. The touch control chip performs transmission of a touch control signal by means of the touch-control bonding terminals, the touch control circuit, and the display touch zone.

In the electronic device according to an embodiment of the application, the driving circuit is electrically connected, by means of the first conduction layer, to the bonding terminals located in the bonding zone, and the touch control circuit is extended, by means of the second conduction layer, across the bending zone and is then connected, by means of the first conduction layer, to the bonding terminals located n the bonding zone. In this way, there is no need for line-switching of the touch control circuit to the driving circuit layer, and a distance necessary for line-switching of the second conduction layer in the bending zone toward the first conduction layer can be saved, so that the bending zone of the display panel can be made closer to the display touch zone, and after bending of the side frame zone, a spacing distance between an edge of the display touch zone and the side frame zone is lessened, achieving an effect of further narrowing the side frame of the display panel, thereby resolving the technical issue that the frame width of a known display panel cannot be further reduced.

It is appreciated from the above embodiments:

The application provides, in embodiments thereof, a display panel and an electronic device. The display panel comprises a display touch zone and a side frame zone. The side frame zone comprises a bending zone and a bonding zone. The display panel comprises a driving circuit layer, a light emission function layer, and a touch control function layer. The driving circuit layer is formed with a driving circuit. The touch control function layer is formed with a touch control circuit. In the side frame zone, the display panel comprises a first conduction layer and a second conduction layer. The driving circuit is electrically connected, by means of the first conduction layer, to the bonding terminals located in the bonding zone. The touch control circuit is extended, by means of the second conduction layer, across the bending zone and is then connected, by means of the first conduction layer, to the bonding terminals located in the bonding zone. The driving circuit is electrically connected, by means of the first conduction layer, to the bonding terminals located in the bonding zone, and the touch control circuit is extended, by means of the second conduction layer, across the bending zone and is then connected, by means of the first conduction layer, to the bonding terminals located in the bonding zone. In this way, there is no need for line-switching of the touch control circuit to the driving circuit layer, and a distance necessary for line-switching of the second conduction layer in the bending zone toward the first conduction layer can be saved, so that the bending zone of the display panel can be made closer to the display touch zone, and after bending of the side frame zone, a spacing distance between an edge of the display touch zone and the side frame zone is lessened, achieving an effect of further narrowing the side frame of the display panel, thereby resolving the technical issue that the frame width of a known display panel cannot be further reduced.

In the above embodiments, the descriptions made to the various embodiments may be individually focused on different parts, and as such, certain details that are missing in one embodiment may refer to related descriptions of other embodiments.

A detailed description has been provided above for a display panel and an electronic device according to embodiments of the application. Specific examples are involved in the disclosure for expounding the principle of and the ways of embodying the application. The description provided above is only for helping understand the technical solution and the core idea of the application. Those having ordinary skill in the art may appreciate that it is still possible to make modification on the technical solution described above with reference to the embodiments, or some of the technical features may be substitute in an equivalent way. Such modification and substitution do not make related technical solutions departing from the scope of the technical solution provided in each embodiment of the application.

What is claimed is:

1. A display panel, comprising a display touch zone and a side frame zone, wherein the side frame zone comprises a bending zone and a bonding zone, and the display panel comprises:
a driving circuit layer comprising a driving circuit;
a light emission function layer; and
a touch control function layer comprising a touch control circuit; and
wherein the display panel further comprises a first conduction layer and a second conduction layer located in the side frame zone, the driving circuit is electrically connected to bonding terminals located in the bonding zone by the first conduction layer, and the touch control circuit extends across the bending zone by the second conduction layer and is connected to the bonding terminals located in the bonding zone by the first conduction layer.

2. The display panel according to claim 1, wherein in the bending zone, the first conduction layer is located on a side of the second conduction layer subject to bending, and the first conduction layer is configured to be a constant voltage signal circuit.

3. The display panel according to claim 1, wherein the second conduction layer comprises a touch-control-circuit connection section and a bonding-terminal connection section, one end of the touch-control-circuit connection section is electrically connected to the touch control circuit, another end of the touch-control-circuit connection section is connected to an end of the bonding-terminal connection section in the bending zone, and another end of the bonding-terminal connection section is connected to the bonding terminals.

4. The display panel according to claim 2, wherein the second conduction layer comprises a touch-control-circuit connection section and a bonding-terminal connection section, one end of the touch-control-circuit connection section is electrically connected to the touch control circuit, another end of the touch-control-circuit connection section is connected to an end of the bonding-terminal connection section in the bending zone, and another end of the bonding-terminal connection section is connected to the bonding terminals.

5. The display panel according to claim 4, wherein the bonding-terminal connection section and the touch-control-circuit connection section are configured to be connected such that wirings of the bonding-terminal connection section and wirings of the touch-control-circuit connection section form an included angle ranging from 30° to 150°.

6. The display panel according to claim 1, wherein the bonding terminals comprises drive bonding terminals and touch-control bonding terminals, the touch-control bonding terminals are located on two side portions of the bonding zone, the drive bonding terminals are located on a middle portion of the bonding zone, the first conduction layer is electrically connected to the drive bonding terminals, and the second conduction layer is electrically connected to the touch-control bonding terminals.

7. The display panel according to claim 6, wherein the second conduction layer and the touch-control bonding terminals are configured to be connected such that wirings of the second conduction layer and the touch-control bonding terminals form an included angle ranging from to 170°.

8. The display panel according to claim 6, wherein the first conduction layer is located in a middle area of the second conduction layer, and at least a portion of the second conduction layer overlaps the first conduction layer.

9. The display panel according to claim 1, wherein the second conduction layer comprises a plurality of touch wirings, each of the touch wirings comprises a plurality of curving portions and a plurality of linear portions, and the curving portions and the linear portions are alternately arranged in intervals with each other.

10. The display panel according to claim 9, wherein the curving portions comprises first curving portions and second curving portions, a curving direction of the first curving portions is opposite to a curving direction of the second curving portions, and each of the linear portions has an end connected to the first curving portions and another end connected to the second curving portions.

11. An electronic device, comprising a display panel, a drive chip, and a touch control chip, wherein the display panel comprises a display touch zone and a side frame zone, the side frame zone comprises a bending zone and a bonding zone, and the display panel comprises:
a driving circuit layer comprising a driving circuit;
a light emission function layer; and
a touch control function layer comprising a touch control circuit; and
wherein, the display panel further comprises a first conduction layer and a second conduction layer located in the side frame zone, the driving circuit is electrically connected to bonding terminals located in the bonding zone by the first conduction layer, and the touch control circuit extends across the bending zone by the second conduction layer and is connected to the bonding terminals located in the bonding zone by the first conduction layer.

12. The electronic device according to claim 11, wherein in the bending zone, the first conduction layer is located on a side of the second conduction layer subject to bending, and the first conduction layer is configured to be a constant voltage signal circuit.

13. The electronic device according to claim 11, wherein the second conduction layer comprises a touch-control-circuit connection section and a bonding-terminal connection section, one end of the touch-control-circuit connection section is electrically connected to the touch control circuit, another end of the touch-control-circuit connection section is connected to an end of the bonding-terminal connection section in the bending zone, and another end of the bonding-terminal connection section is connected to the bonding terminals.

14. The electronic device according to claim 12, wherein the second conduction layer comprises a touch-control-circuit connection section and a bonding-terminal connection section, one end of the touch-control-circuit connection section is electrically connected to the touch control circuit, another end of the touch-control-circuit connection section is connected to an end of the bonding-terminal connection section in the bending zone, and another end of the bonding-terminal connection section is connected to the bonding terminals.

15. The electronic device according to claim 14, wherein the bonding-terminal connection section and the touch-control-circuit connection section are configured to be connected such that wirings of the bonding-terminal connection section and wirings of the touch-control-circuit connection section form an included angle ranging from 30° to 150°.

16. The electronic device according to claim 11, wherein the bonding terminals comprises drive bonding terminals and touch-control bonding terminals, the touch-control bonding terminals are located on two side portions of the bonding zone, the drive bonding terminals are located on a middle portion of the bonding zone, the first conduction layer is electrically connected to the drive bonding terminals, and the second conduction layer is electrically connected to the touch-control bonding terminals.

17. The electronic device according to claim 16, wherein the second conduction layer and the touch-control bonding terminals are configured to be connected such that wirings of the second conduction layer and the touch-control bonding terminals form an included angle ranging from 90° to 170°.

18. The electronic device according to claim 16, wherein the first conduction layer is located in a middle area of the second conduction layer, and at least a portion of the second conduction layer overlaps the first conduction layer.

19. The electronic device according to claim 11, wherein the second conduction layer comprises a plurality of touch wirings, each of the touch wirings comprises a plurality of curving portions and a plurality of linear portions, and the curving portions and the linear portions are alternately arranged in intervals with each other.

20. The electronic device according to claim 19, wherein the curving portions comprises first curving portions and second curving portions, a curving direction of the first curving portions is opposite to a curving direction of the second curving portions, and each of the linear portions has an end connected to the first curving portions and another end connected to the second curving portions.
